(19) United States
(12) Patent Application Publication
(10) Pub. No.: US 2010/0118432 A1
(43) Pub. Date: May 13, 2010

(54) MAGNETIC STORAGE APPARATUS

(75) Inventor: Motomichi Shibano, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/569,538

(22) Filed: Sep. 29, 2009

(30) Foreign Application Priority Data
Nov. 12, 2008 (JP) 2008-290353

(51) Int. Cl. G11B 15/14; H01F 13/00

(52) U.S. Cl. 360/64; 29/604; G9B/15.018

(57) ABSTRACT

According to one embodiment, a magnetic storage apparatus includes a magnetic storage medium that includes a servo pattern in which magnetic bodies magnetized to one of an S-pole and an N-pole are discretely arranged in a non-magnetic substance at least in a recording track line direction, an electromagnetic conversion element configured to output a reproduction signal according to a magnetic field leaking from the magnetic bodies; a rectifier circuit configured to receive the reproduction signal swinging from positive to negative and vice versa corresponding to a magnetic pole, and generate a reproduction signal swinging to either a positive or negative direction according to the reproduction signal; and a control circuit configured to cause the electromagnetic conversion element to be positioned to a single recording track on the magnetic storage medium according to the reproduction signal generated in the rectifier circuit.

### CROSS-REFERENCE TO RELATED APPLICATIONS

This application is based upon and claims the benefit of priority from Japanese Patent Application No. 2008-290353, filed Nov. 12, 2008, the entire contents of which are incorporated herein by reference.

### BACKGROUND

1. Field

One embodiment of the present invention relates to a magnetic storage medium that is incorporated in a magnetic storage apparatus, and has a servo pattern in which magnetic bodies magnetized to a south pole (S-pole) or a north pole (N-pole) are discretely arranged in a non-magnetic substance at least in a line direction of a recording track.

2. Description of the Related Art

Magnetic storage medium such as a bit-patterned media are widely known. In such magnetic storage media, when a servo pattern is set up, magnetic bodies are arranged in a non-magnetic substance with any pattern. The magnetic bodies are magnetized in a unidirectional magnetic field. In a servo pattern, magnetic pole of the magnetic bodies is adjusted to one of the magnetic poles (see, for example, Japanese Patent Application Publication (KOKAI) No. 2008-77772).

When adjacent magnetic bodies are magnetized in an opposite direction to each other, the magnetic field circulates. Therefore, the magnetization is less likely to be reversed. On the other hand, when adjacent magnetic bodies are magnetized in the same direction to each other, the magnetization is likely to be reversed. When the magnetization of the servo pattern is reversed, servo pattern cannot be read correctly in the tracking servo control.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view of an internal structure of a magnetic storage medium drive apparatus, i.e., a hard disk drive (HDD) apparatus, according to an embodiment of the invention;

FIG. 2 is an exemplary partially enlarged schematic of a surface structure of a magnetic disk in the embodiment;

FIG. 3 is an exemplary enlarged perspective view of the surface of the magnetic disk in the embodiment;

FIG. 4 is an exemplary vertical cross-sectional view taken along the line 4-4 in FIG. 3 according to the embodiment;

FIG. 5 is an exemplary partially enlarged schematic of a servo sector area in the embodiment;

FIG. 6 is an exemplary block diagram of a tracking servo control system in the embodiment;

FIG. 7 is an exemplary schematic of a rectifier circuit in the embodiment;

FIG. 8 is another exemplary schematic of the rectifier circuit in the embodiment;

FIG. 9 is an exemplary schematic waveform of a reproduction waveform swinging from positive to negative and vice versa with respect to a reference voltage of 0 V in the embodiment;

FIG. 10 is an exemplary schematic waveform of a direct current offset and a low-frequency wave component extracted from the reproduction waveform in the embodiment;

FIG. 11 is an exemplary schematic reproduction waveform swinging from positive to negative and vice versa with respect to a reference voltage of 0 V, with a direct current offset and a wave component corrected in the embodiment;

FIG. 12 is an exemplary schematic unidirectional reproduction waveform after conversion to an absolute value in the embodiment; FIG. 13 is an exemplary schematic of a preamplifier comprising the rectifier circuit in the embodiment;

FIG. 14 is another exemplary schematic of the preamplifier comprising the rectifier circuit in the embodiment;

FIG. 15 is an exemplary partially enlarged cross-sectional view of the magnetic disk having a magnetic film laminated on a non-magnetic intermediate layer during a manufacturing process of the magnetic disk in the embodiment;

FIG. 16 is an exemplary partially enlarged cross-sectional view of the magnetic disk having a resist film formed on a surface of the magnetic film during the manufacturing process of the magnetic disk in the embodiment;

FIG. 17 is an exemplary partially enlarged cross-sectional view of the magnetic disk having the patterned magnetic film during the manufacturing process of the magnetic disk in the embodiment;

FIG. 18 is an exemplary partially enlarged cross-sectional view of the magnetic disk having a planarized recording layer during the manufacturing process of the magnetic disk in the embodiment; and

FIG. 19 is an exemplary schematic waveform of a reproduction signal read from the servo sector area to which a high-frequency write signal has been applied.

### DETAILED DESCRIPTION

Various embodiments according to the invention will be described hereinafter with reference to the accompanying drawings. In general, according to one embodiment of the invention, a magnetic storage apparatus comprises a magnetic storage medium that comprises a servo pattern in which magnetic bodies magnetized to one of an S-pole and an N-pole are discretely arranged in a non-magnetic substance at least in a recording track line direction, an electromagnetic conversion element configured to output a reproduction signal according to a magnetic field leaking from the magnetic bodies, a rectifier circuit configured to receive the reproduction signal swinging from positive to negative and vice versa corresponding to a magnetic pole, and generate a reproduction signal swinging to either a positive or negative direction according to the reproduction signal, and a control circuit configured to cause the electromagnetic conversion element to be positioned to a single recording track on the magnetic storage medium according to the reproduction signal generated in the rectifier circuit.

According to another embodiment of the invention, a manufacturing method of a magnetic storage medium comprises magnetizing, in a servo pattern of the magnetic storage medium, magnetic bodies that are discretely arranged in a non-magnetic substance at least in a recording track line direction with a high-frequency write signal.

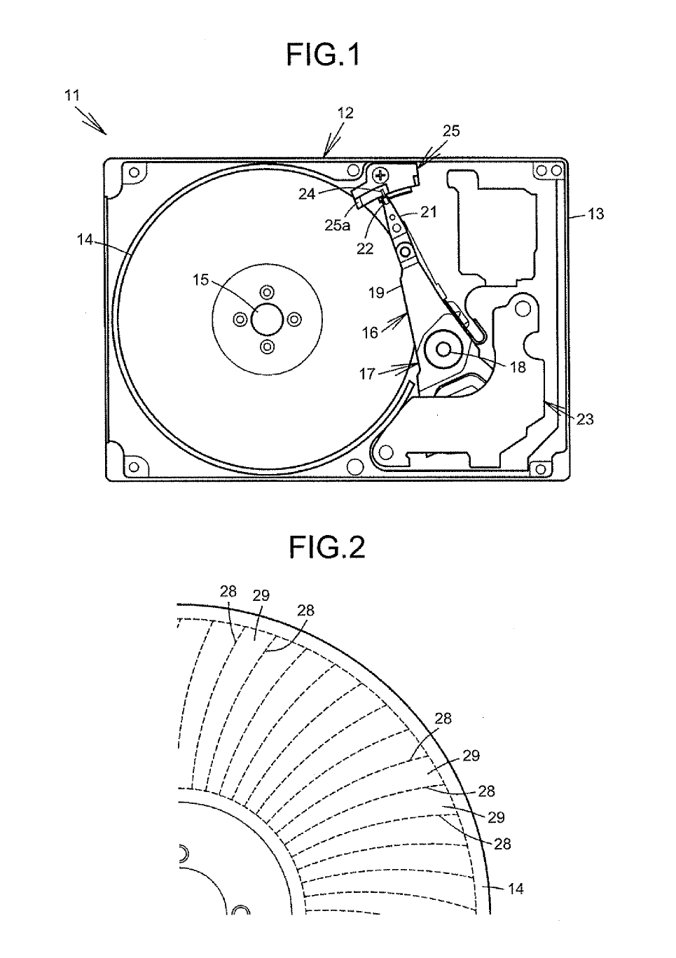

FIG. 1 is a schematic of an internal structure of an embodiment of a magnetic storage apparatus according to the present invention, that is, a hard disk drive (HDD) 11. The HDD 11 comprises a casing, that is, a housing 12. The housing 12 comprises a box-shaped base 13 and a cover (not depicted). The base 13 partitions an interior space having, for example, a flat rectangular cuboid shape, that is, a housing space. The base 13 may be formed, for example, by casting metallic material such as aluminum (Al). The cover is connected to an opening of the base 13. The cover and the base 13 seal the housing space. The cover maybe formed, for example, by pressing a piece of plate material.

In the housing space, one or more magnetic disks 14 are arranged. The magnetic disk 14 is an example of a magnetic storage medium. The magnetic disk 14 is mounted on a spindle hub of a spindle motor 15. The spindle motor 15 can rotate the magnetic disks 14 at a high speed of, for example, 5400 rpm, 7200 rpm, 10000 rpm, or 15000 rpm. The individual magnetic disks 14 are recognized as so-called bit patterned media, which will be described later.

A carriage 16 is also housed in the housing space. The carriage 16 comprises a head stack assembly 17. The head stack assembly 17 is rotatably connected to a spindle 18 that extends vertically from a bottom plate of the base 13. A plurality of carriage arms 19 that horizontally extends from the spindle 18 is partitioned in the head stack assembly 17. The head stack assembly 17 may be formed by, for example, extruding aluminum (Al) .

A head suspension 21 is mounted on a tip of each of the carriage arms 19. The head suspension 21 extends in the forward direction from the tip of the carriage arm 19. A flexure is attached to a tip of the head suspension 21. The flexure supports a floating head slider 22. The floating head slider 22 can change its position with respect to the head suspension 21 by using the flexure. The floating head slider 22 has thereon a head element, i.e., an electromagnetic conversion element (not depicted).

The electromagnetic conversion element comprises a write head element and a read head element. The write head element has a so-called single-pole-type head. The single-pole-type head generates a magnetic field with its thin film coil pattern. The magnetic field is applied to the magnetic disk 14 from the vertical direction orthogonal to the surface of the magnetic disk 14 according to the effect of the main magnetic pole. This magnetic field enables to write information to the magnetic disk 14. On the other hand, the read head element is a giant magneto resistive (GMR) element or a tunneling magneto resistive (TMR) element. With the GMR element or the TMR element, a resistance change of a spin-valve film or a tunnel junction film occurs depending on a direction of the magnetic field from the magnetic disk 14. With such resistance change, information can be read out from the magnetic disk 14.

When the magnetic disk 14 is rotated, air current is generated on the surface of the magnetic disk 14. Then, due to the air current, a positive pressure, that is an ascending force, and a negative pressure are applied on the floating head slider 22. The ascending force and the negative pressure balance with a pressing force of the head suspension 21, and thus, the floating head slider 22 can keep floating at a relatively high rigidity while the magnetic disk 14 is rotated.

To the head stack assembly 17, a voice coil motor (VOM) 23 is linked. The voice coil motor 23 allows the head stack assembly 17 to rotate about the spindle 18. This rotation of the head stack assembly 17 enables the carriage arms 19 and the head suspension 21 to swing. While the floating head slider 22 floats, when the carriage arm 19 swings about the spindle 18, the floating head slider 22 can move along a radius line of the magnetic disk 14. As a result, the electromagnetic conversion element mounted on the floating head slider 22 can traverse the concentric recording track between the innermost recording track and the outermost recording track. Thus, the electromagnetic conversion element can be positioned on a desired recording track according to the movement of the floating head slider 22.

At the tip of the head suspension 21, a load tub 24 extending forward therefrom is partitioned. The load tub 24 can move in the radial direction of the magnetic disk 14 by the swinging of the carriage arm 19. On the moving path of the load tub 24, a ramp member 25 is disposed outside the magnetic disk 14. The ramp member 25 is secured on the base 13 and receives the load tub 24. The ramp member 25 may be formed from a hard plastic material, for example.

The ramp member 25 has a ramp 25a extending along the moving path of the load tub 24. The ramp 25a, when moving away from the rotation axis of the magnetic disk 14, moves away from a virtual plane comprising the surface of the magnetic disk 14. Accordingly, when the carriage arm 19 rotates about the spindle 18 to move away from the rotation axis of the magnetic disk 14, the load tub 24 moves upward on the ramp 25a. Then, the floating head slider 22 is removed from the surface of the magnetic disk 14 to move outside the magnetic disk 14 and rest. On the other hand, when the carriage arm 19 swings about the spindle 18 to move toward the rotation axis of the magnetic disk 14, the load tub 24 moves downward on the ramp 25a. Then, the ascending force due to the rotation of the magnetic disk 14 is applied to the floating head slider 22. The ramp member 25 and the load tub 24 cooperate together to establish a so-called load/unload mechanism.

As illustrated in FIG. 2, servo sector areas 28 as plural curved lines (e.g., 200 lines) extending along the radial direction of the magnetic disk 14 are defined on both surfaces of the magnetic disk 14. The servo sector areas 28 are spaced at regular intervals in the circumferential direction. In the servo sector area 28, a servo pattern is set up. Magnetic information written to the servo pattern is read by using the electromagnetic conversion element on the floating head slider 22. The floating head slider 22 is positioned in the radial direction of the magnetic disk 14 according to the information read from the servo pattern. A circular recording track is defined according to the position of the floating head slider 22. The floating head slider 22 moves in the radial direction to define concentric recording tracks. The curved shape of the servo sector areas 28 are set based on the moving path of the electromagnetic conversion element.

Data areas 29 are formed between adjacent servo sector areas 28. In the data areas 29, the electromagnetic conversion element is positioned according to the servo pattern and travels on the recording tracks. Along the recording tracks, the write head element of the electromagnetic conversion element writes magnetic information, while the read head element of the electromagnetic conversion element reads magnetic information therealong.

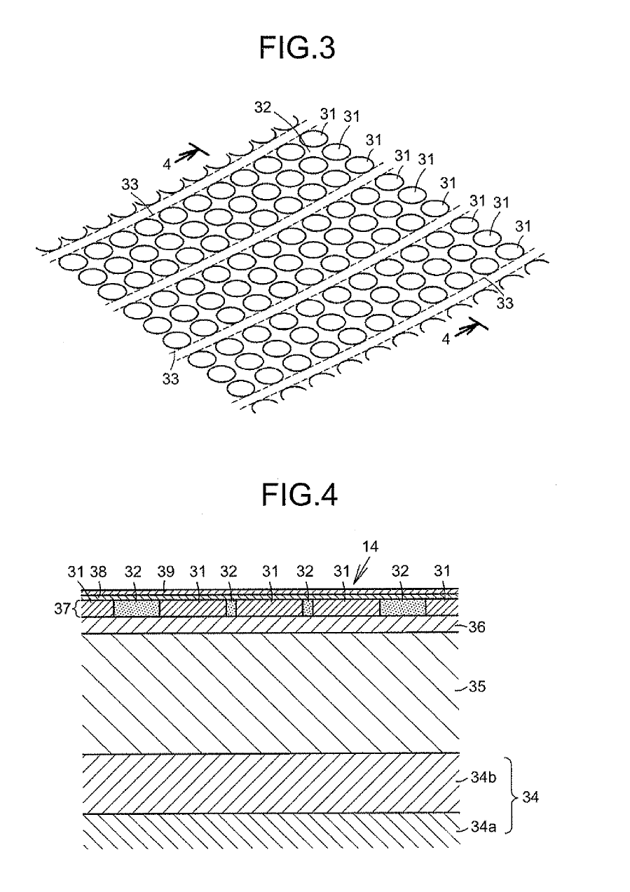

As illustrated in FIG. 3, magnetic dots 31 in plural lines are concentrically arranged on the surface of the magnetic disk 14. The individual magnetic dots 31 are cylinders, that is, magnetic pillars each having a central axis orthogonal to the surface of the magnetic disk 14. A diameter of the magnetic pillar is exemplarily set to about 20 nano millimeters. An interval of the central axes is exemplarily set to about 22 to 23 nano millimeters. The magnetic pillars are separated by a non-magnetic substance 32. In FIG. 3, as an example, three lines of the magnetic pillars form a recording track 33. That is, adjacent recording tracks 33 are magnetically separated by the non-magnetic substance 32. In the individual lines, the magnetic pillars are separated by the non-magnetic substance 32.

FIG. 4 is a cross-sectional structure of the magnetic disk 14. The magnetic disk 14 comprises a base material, i.e., a substrate 34. The substrate 34 may be formed with a disk-shaped Si base 34a, and an amorphous SiO₂ film 34b that extends on both surfaces of the Si base 34a, for example. In the figure, only the front surface of the Si base 34a is illustrated. The substrate 34 may be a glass substrate or an aluminum substrate.

An underlayer 35 extends on the front surface of the substrate 34. The underlayer 35 may be formed with a soft magnetic substance, such as an iron-cobalt-tantalum (FeCoTa) film or a nickel-iron (NiFe) film. The underlayer 35 has therein an easily-magnetizable axis in an in-plane direction parallel to the surface of the substrate 34.

A non-magnetic intermediate layer 36 extends on the front surface of the underlayer 35. The non-magnetic intermediate layer 36 may be formed with a tantalum (Ta) adhesion layer laminated on the front surface of the underlayer 35 and a ruthenium (Ru) layer laminated on the front surface of the tantalum adhesion layer, for example.

A recording layer 37 is formed on the front surface of the non-magnetic intermediate layer 36. The recording layer 37 comprises the magnetic dots 31 disposed on the front surface of the non-magnetic intermediate layer 36. The magnetic dots 31 are formed of a cobalt-iron (CoFe) alloy. Each of the magnetic dots 31 has therein an easily-magnetizable axis in the vertical direction orthogonal to the surface of the substrate 34. The magnetic dots 31 each have a downward magnetization toward the surface of the substrate 34 and an upward magnetization away from the surface of the substrate 34 so as to record binary information. A space between the magnetic dots 31 is filled with the non-magnetic substance 32. The non-magnetic substance 32 is formed of silicon dioxide (SiO₂) , for example. The magnetic dots 31 and the non-magnetic substance 32 form a flat surface. The flat surface, i.e., the front surface of the recording layer 37 is coated with a protective film 38 such as a diamond-like carbon (DLC) film, and a lubricating film 39 such as a perfluoropolyether (PFPE) film. Similarly, on the back surface of the substrate 34, the underlayer 35, the non-magnetic intermediate layer 36, the recording layer 37, the protective film 38, and the lubricating film 39 are laminated in this order.

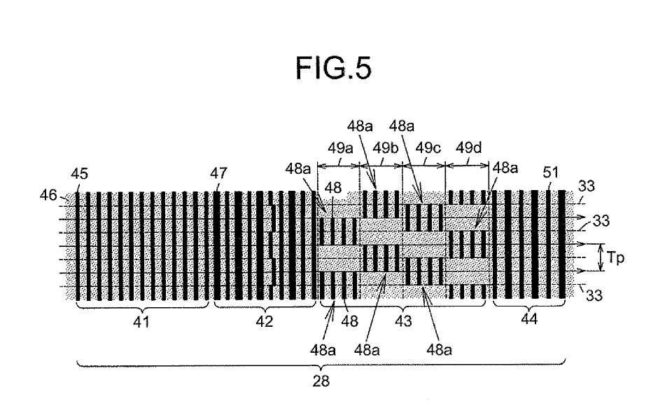

FIG. 5 is an example of the servo sector areas 28. Each of the servo sector areas 28 comprises a preamble 41, a servo mark address 42, an amplitude/burst 43, and a recording/reproducing timing mark 44, in this order from an upstream side. The preamble 41, the servo mark address 42, the amplitude/burst 43, and the recording/reproducing timing mark 44 together forma servo pattern. In the preamble 41, magnetic bodies 45 in plural lines are arranged in a non-magnetic substance 46. The individual magnetic bodies 45 extend in the radial direction of the magnetic disk 14, for example. The magnetic bodies 45 are each magnetized to an N-pole or an S-pole. According to an arrangement of the magnetic bodies 45, a specific magnetic pattern is set up on the single recording track 33. The magnetic bodies 45 are spaced at regular intervals in the circumferential direction of the magnetic disk 14, for example. A size of the magnetic bodies 45 is determined based on a magnitude of the magnetic field produced by the write head element of the electromagnetic conversion element or material characteristics of the magnetic bodies 45. The magnetization direction of a single magnetic body 45 is uniformed. Therefore, the preamble 41 ensures that signals read from the read head element of the electromagnetic conversion element are synchronized. At the same time, gain is adjusted according to the signals read from the read head element of the electromagnetic conversion element. The “upstream side” and the “downstream side” are specified by the traveling direction of the floating head slider 22 determined while the magnetic disk 14 rotates.

Similarly, in the servo mark address 42, magnetic bodies 47 in plural lines are arranged in the non-magnetic substance 46. The individual magnetic bodies 47 extend in the radial direction of the magnetic disk 14. The magnetic bodies 47 are each magnetized to an N-pole or an S-pole. A size of the magnetic bodies 47 is determined based on a magnitude of the magnetic field produced by the write head element of the electromagnetic conversion element or material characteristics of the magnetic bodies 47. The magnetization direction of each single magnetic body 47 is uniformed. With this arrangement of the magnetic bodies 47, a specific magnetic pattern is set up on the single recording track 33. Magnetic patterns are different from one recording track 33 to another, and reflect track numbers. At the same time, a specific magnetic pattern common to the recording tracks 33 is set up. This magnetic pattern reflects sector numbers.

Similarly, in the amplitude/burst 43, magnetic bodies 48 in plural lines are arranged in the non-magnetic substance 46. The individual magnetic bodies 48 extend in the radial direction of the magnetic disk 14. The magnetic bodies 48 are sectioned into a track width of the recording track, i.e., a track pitch Tp, in the radial direction of the magnetic disk 14. A prescribed number of the magnetic bodies 48 form a single burst group 48a. In a first area 49a of the uppermost stream, two adjacent burst groups 48a have an interval therebetween of a track pitch Tp in the radial direction of the magnetic disk 14. Similarly, in a second area 49b that is downstream of the first area 49a and adjacent thereto, two adjacent burst groups 48a have an interval therebetween of a track pitch Tp in the radial direction of the magnetic disk 14. The burst groups 48a in the second area 49b and the burst groups 48a in the first area 49a are displaced by one track pitch Tp in the radial direction of the magnetic disk 14. Similarly, in a third area 49c that is downstream of the second area 49b and adjacent thereto, two adjacent burst groups 48a have an interval therebetween of a track pitch Tp in the radial direction of the magnetic disk 14. The burst groups 48a in the third area 49c and the burst groups 48a in the second area 49b are displaced by a half track pitch Tp in the radial direction of the magnetic disk 14. Similarly, in a fourth area 49d that is downstream of the third area 49c and adjacent thereto, two adjacent burst groups 48a have an interval therebetween of a track pitch Tp in the radial direction of the magnetic disk 14. The burst groups 48a in the fourth area 49d and the burst groups 48a in the third area 49c are displaced by one track pitch Tp in the radial direction of the magnetic disk 14. The electromagnetic conversion element moving along the central line of the recording track 33 passes the burst groups 48a in the first area 49a and the second area 49b sequentially. Then, in both areas, the magnetic fields at the same level of strength are detected, and reproduction signals at the same level of intensity are sequentially output. When the electromagnetic conversion element deviates from the central line of the recording track 33, magnetic field of the first area 49a or the second area 49b increases in strength. The other magnetic field of the first area 49a and the second area 49b than the one increased in strength decreases in strength. A difference occurs between the levels of reproduction signals subsequently output based on the amount of difference between the strengths. This difference is used to perform tracking control of the electromagnetic conversion element.

In the recording/reproducing timing mark 44, magnetic bodies 51 in plural lines are arranged in the non-magnetic substance 46. The individual magnetic bodies 51 extend in the radial direction of the magnetic disk 14, for example. The magnetic bodies 51 are each magnetized to an N-pole or an S-pole. According to an arrangement of the magnetic bodies 51, a specific magnetic pattern is set up on the single recording track 33. A size of the magnetic bodies 51 is determined based on a magnitude of the magnetic field produced by the write head element of the electromagnetic conversion element or material characteristics of the magnetic bodies 51. The magnetization direction of a single magnetic body 51 is uniformed. Thus, the recording/reproducing timing mark 44 ensures the timing of the read and write operations by the electromagnetic conversion element.

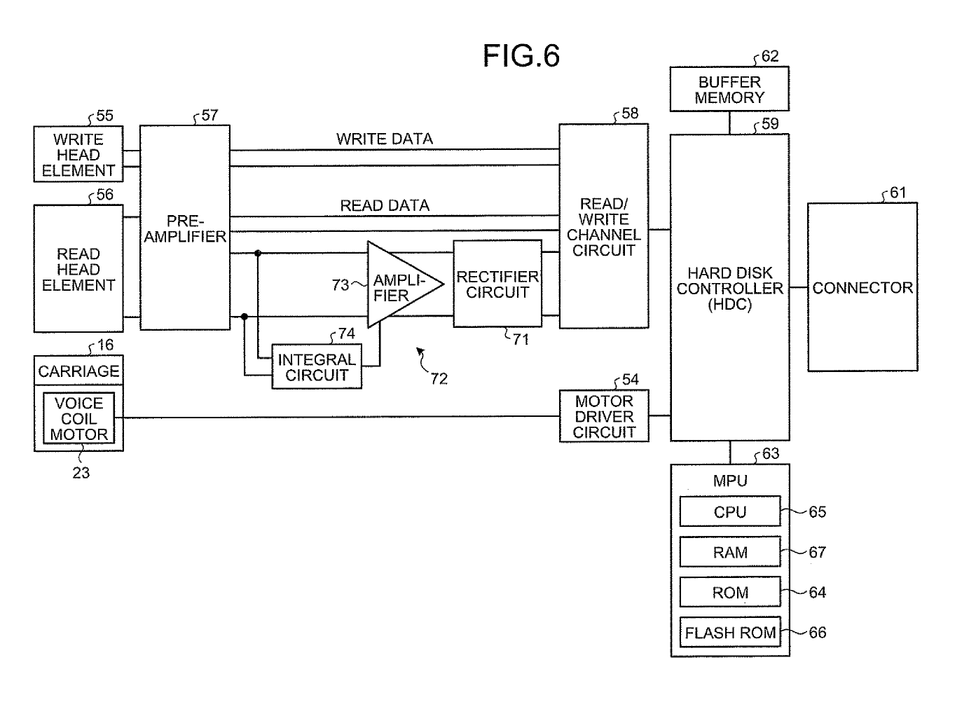

As illustrated in FIG. 6, a motor driver circuit 54 is connected to the voice coil motor 23. The motor driver circuit 54 supplies driving current to the voice coil motor 23. The voice coil motor 23 is driven by the supplied driving current with the displacement amount determined by a rotation amount (rotation angle) of the head stack assembly 17.

To a write head element 55 and a read head element 56 of the electromagnetic conversion element, a preamplifier 57 is connected. To the preamplifier 57, a read/write channel circuit 58 is connected. The read/write channel circuit 58 modulates and demodulates a signal according to a predetermined modulation/demodulation method. When the electromagnetic conversion element passes the data area 29, which is out of the servo sector area 28, a modulated signal, i.e., a write signal is supplied to the preamplifier 57. The preamplifier 57 converts the write signal to the write current signal. The converted write current signal is supplied to the write head element 55. Similarly, when the electromagnetic conversion element passes the data area 29, a read signal output from the read head element 56 is amplified by the preamplifier 57 to supply the signal to the read/write channel circuit 58. The read/write channel circuit 58 demodulates the read signal.

To the motor driver circuit 54 and the read/write channel circuit 58, a hard disk controller (HDC) 59 is connected. The HDC 59 supplies a control signal to the motor driver circuit 54 so as to control the output, i.e., the driving current, of the motor driver circuit 54. Similarly, the HDC 59 transmits an unmodulated write signal to the read/write channel circuit 58, while receiving a demodulated read signal from the read/write channel circuit 58. An unmodulated write signal may be generated with the HDC 59 based on data transmitted from a host computer, for example. Such data may be transmitted to the HDC 59 via a connector 61. To the connector 61, a control signal cable or a power cable (both are not depicted) from a main board of the host computer may be connected, for example. Moreover, the HDC 59 reproduces data based on the demodulated read signal. The reproduced data may be output from the connector 61 to the host computer. The HDC 59, when exchanging data, can use a buffer memory 62, for example. The buffer memory 62 temporarily stores data therein. The buffer memory 62 may comprise a synchronous dynamic random access memory (SDRAM), for example.

To the HDC 59, a microprocessor unit (MPU) 63 is connected. The MPU 63 has a central processing unit (CPU) 65 that runs a computer program stored in a read only memory (ROM) 64, for example. The computer program is a tracking servo control program according to an embodiment. The tracking servo control program may be provided as so-called firmware. The CPU 65 can, for example, obtain data from a flash ROM 66 upon operating. Such a computer program and data can be temporarily stored in a random access memory (RAM) 67. The ROM 64, the flash ROM 66, and the RAM 67 may be directly connected to the CPU 65.

The write head element 55 of the electromagnetic conversion element, when writing data, faces the data area 29 in the magnetic disk 14. The electromagnetic conversion element is positioned in a radial direction of the magnetic disk 14 according to the tracking servo control. Details of the tracking servo control will be described later. At the same time, the recording/reproducing timing mark 44 specifies the write operation timing according to the rotation of the magnetic disk 14. The HDC 59 generates a write signal based on data supplied from the host computer, for example. The write signal is transmitted to the read/write channel circuit 58. The read/write channel circuit 58 modulates the write signal according to a predetermined modulation method. The modulated write signal is converted by the preamplifier 57. The converted write current signal is supplied to the write head element 55. The write head element 55 performs a write operation. The magnetic disk 14 rotates at a constant speed according to the servo control, for example.

Similarly, the read head element 56 of the electromagnetic conversion element, when reading data, faces the data area 29 in the magnetic disk 14. The electromagnetic conversion element is positioned in a radial direction of the magnetic disk 14 according to the tracking servo control. The recording/reproducing timing mark 44 specifies the read operation timing according to the rotation of the magnetic disk 14. The read/write channel circuit 58 supplies a sense current to the read head element 56. A voltage change according to the magnetization direction of the data area 29 is monitored with the sense current. The voltage change is amplified by the preamplifier 57. To the preamplifier 57, a direct current bias is applied through a coupling capacitance. As a result, a positive voltage is output from the preamplifier 57, depending on one of an N-pole and an S-pole. On the other hand, a negative voltage is output from the preamplifier 57, depending on the other pole. That is, the preamplifier 57 outputs a reproduction signal with a voltage change swinging from positive to negative and vice versa. The read/write channel circuit 58 demodulates the reproduction signal. The HDC 59 reproduces data from the demodulated reproduction signal. The reproduced data is output from the connector 61 to the host computer.

A rectifier circuit 71 is connected between the preamplifier 57 and the read/write channel circuit 58. The rectifier circuit 71, according to a reproduction signal swinging from positive to negative and vice versa, generates a reproduction signal swinging only to either the positive or negative direction. That is, a reproduction signal swinging from positive to negative is turned into, for example, a positive reproduction signal regarding the absolute value. The rectifier circuit 71 supplies a rectified reproduction signal to the read/write channel circuit 58.

An offset correction circuit 72 is connected at a preceding stage of the rectifier circuit 71. The offset correction circuit 72 has an amplifier 73 that is connected between the rectifier circuit 71 and the preamplifier 57. To the amplifier 73, the reproduction signal is supplied by the preamplifier 57. An integral circuit 74 is also connected to the amplifier 73. A bias voltage is applied to the amplifier 73 with the integral circuit 74. When the bias voltage is generated, the reproduction signal is supplied to an input terminal of the integral circuit 74 from the preamplifier 57. With the integral circuit 74, a direct current offset and a low-frequency wave component are extracted from the reproduction signal. With the amplifier 73, the direct current offset is eliminated from the reproduction signal swinging from positive to negative and vice versa. As a result, symmetry with respect to the reference voltage of 0 volt (V) is improved. In the rectifier circuit 71, the absolute value is generated according to the corrected reproduction signal. Accordingly, the amplitude fluctuation is eliminated so that amplitude of the output of the rectifier circuit 71 is moderate.

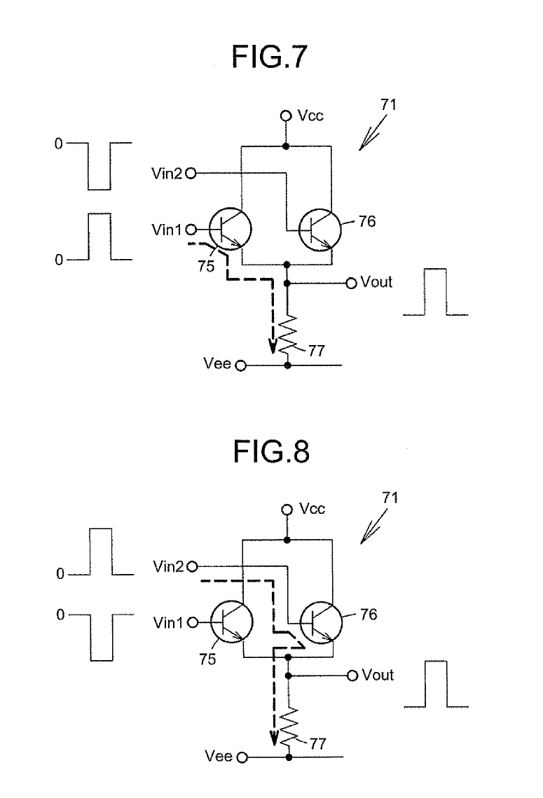

FIG. 7 is an example of the rectifier circuit 71. The rectifier circuit 71 comprises a first transistor circuit 75 and a second transistor circuit 76. The first and the second transistor circuits 75 and 76 each have a collector to which a voltage Vcc is commonly applied, and an emitter to which a resistance 77 is commonly connected. An output voltage Vout is derived from the emitters. The first transistor circuit 75 has a base to which a positive polarity output signal Vin1 is supplied by the preamplifier 57. The second transistor circuit 76 has a base to which a reverse polarity output signal Vin2 is supplied by the preamplifier 57.

As is evident from FIG. 7, when a positive voltage is supplied to the positive polarity output signal Vin1, a signal is fed to the first transistor circuit 75. In this case, a negative voltage is supplied to the reverse polarity output signal Vin2. Accordingly, no voltage is fed to the second transistor circuit 76. The output of the positive polarity output signal Vin1 is reflected in the output voltage Vout. As illustrated in FIG. 8, when a negative voltage is supplied to the positive polarity output signal Vin1, no voltage is fed to the first transistor circuit 75. On the other hand, a positive voltage is supplied to the reverse polarity output signal Vin2 to feed a signal to the second transistor circuit 76. The output of the reverse polarity output signal Vin2 is reflected in the output voltage Vout. The positive polarity signal and the reverse polarity signal are supplied to the read/write channel circuit 58. Therefore, two lines of the rectifier circuit 71 are connected to the read/write channel circuit 58. One input of the rectifier circuit 71 is exchangeable with the other input of the rectifier circuit 71.

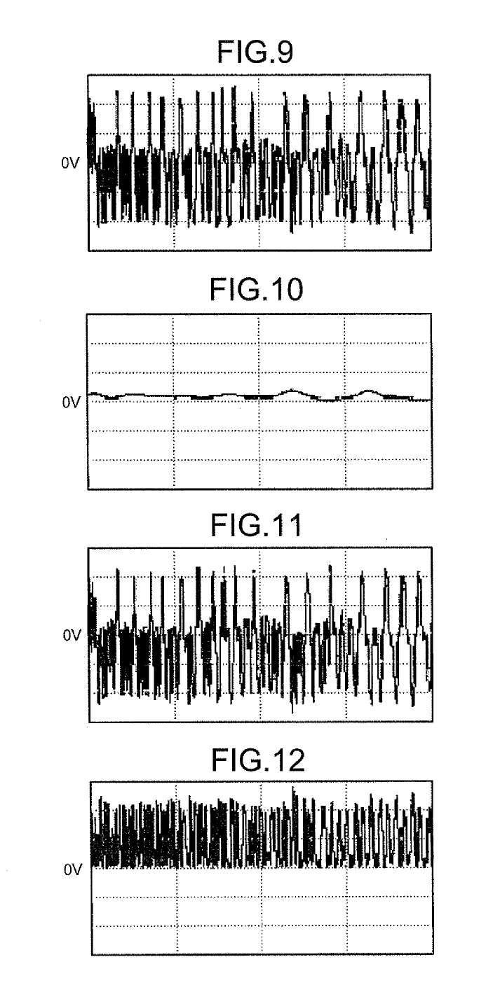

Following is a scenario of the tracking servo control. The read head element 56 of the electromagnetic conversion element faces the servo sector area 28 in the magnetic disk 14. When the magnetic disk 14 rotates, the read head element 56 passes through the preamble 41, the servo mark address 42, the amplitude/burst 43, and the recording/reproducing timing mark 44, in this order. A voltage change according to the magnetization direction of the magnetic body is monitored with the sense current. The voltage change is amplified by the preamplifier 57. A reproduction waveform swinging from positive to negative and vice versa with respect to the reference voltage of 0 V, as illustrated in FIG. 9, is output through the coupling capacitance. This reproduction waveform is input to the amplifier.

The reproduction waveform swinging from positive to negative and vice versa is concurrently supplied to the integral circuit 74. As illustrated in FIG. 10, with the integral circuit 74, a direct current offset and a low-frequency wave component are extracted from the reproduction signal. A bias voltage is applied to the amplifier 73 with the integral circuit 74. The bias voltage is subtracted from the reproduction waveform output by the preamplifier 57. As a result, the direct current offset is subtracted from the reproduction waveform swinging from positive to negative and vice versa. As illustrated in FIG. 11, the amplifier 73 supplies the corrected reproduction waveform to the rectifier circuit 71. Symmetry with respect to the reference voltage of 0 V is improved in the corrected reproduction waveform.

As illustrated in FIG. 12, the absolute value of the reproduction waveform swinging from positive to negative and vice versa is generated with the rectifier circuit 71. Then, the reproduction waveform swings only to the positive direction with respect to the reference voltage of 0 V. That is, a unidirectional reproduction waveform is obtained. As described above, because the symmetry with respect to the reference voltage of 0 V is improved in the corrected reproduction waveform, the amplitude fluctuation in the unidirectional reproduction waveform is maximally eliminated. Thereafter, the unidirectional reproduction waveform is supplied to the read/write channel circuit 58. The read/write channel circuit 58 generates a position error signal based on the unidirectional reproduction waveform. By using the position error signal, the HDC 59 calculates a driving amount of the voice coil motor 23. Then, the HDC 59 outputs a control signal to the motor driver circuit 54 based on the obtained driving amount. With the motor driver circuit 54, the obtained driving amount is supplied to the voice coil motor 23. Thus, the electromagnetic conversion element is positioned on the specified recording track.

As illustrated in FIG. 13, the rectifier circuit 71 may be incorporated in the preamplifier 57. The preamplifier 57 comprises a first stage amplifier circuit 81 and a subsequent stage gain amplifier circuit 82. A high pass filter 83 is inserted between the first stage amplifier circuit 81 and the gain amplifier circuit 82. The high pass filter 83 removes a direct current component in the reproduction signal, i.e., the output of the first stage amplifier circuit 81. The rectifier circuit 71 is inserted between the output of the first stage amplifier circuit 81 and the high pass filter 83 in parallel. A switching element 86 is interposed between the first stage amplifier circuit 81 and the high pass filter 83. The switching element 86 switches a first path 84 that is directly connected to the high pass filter 83 from the output of the first stage amplifier circuit 81, and a second path 85 connected to the high pass filter 83 from the output of the first stage amplifier circuit 81 through the rectifier circuit 71. The reproduction signal from the data area 29 passes through the first path 84. The reproduction signal from the servo sector area 28 passes through the second path 85. The rectifier circuit 71, from a reproduction signal swinging from positive to negative and vice versa, generates the unidirectional reproduction signal swinging only to the positive direction with respect to the reference voltage of 0 V, as described above. The switching operation interacts with a servo gate signal. When the reproduction signal swinging from positive to negative and vice versa passes through the high pass filter 83, sag is generated in the reproduction signal on removal of the direct current component. The sag degrades the symmetry of the reproduction signal. The absolute value of the reproduction signal is generated before the reproduction signal passes through the high pass filter 83, and then, distortion of the reproduction waveform is suppressed to reduce the error rate. This type of the preamplifier 57 can be integrated, for example, in a semiconductor element as one-chip.

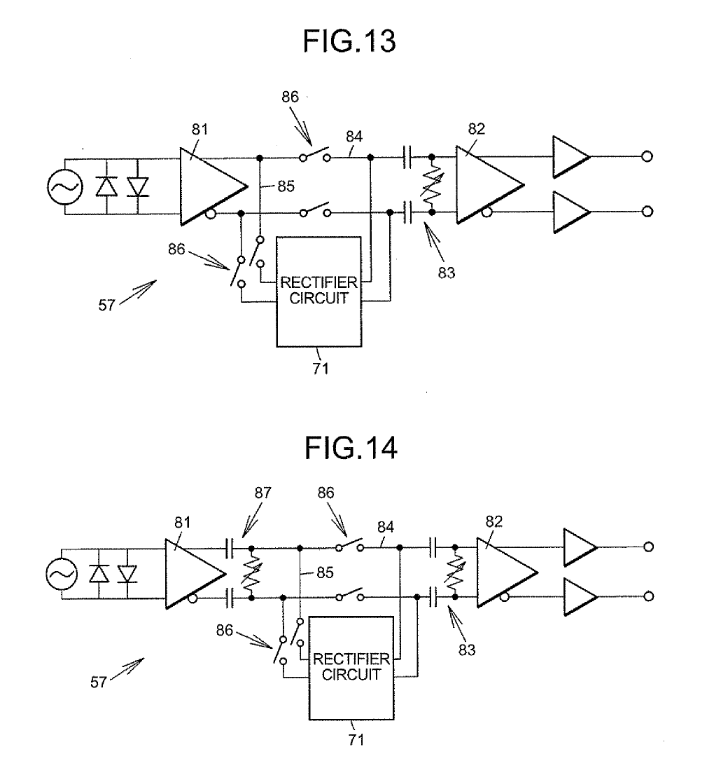

Moreover, as illustrated in FIG. 14, a first stage high pass filter 87 can be inserted at the preceding stage of the rectifier circuit 71 in the preamplifier 57. A cutoff frequency is set to low at the first stage high pass filter 87, such as about 100 kilohertz (kHz). An attenuation factor is set to about −10 decibel (dB). The cutoff frequency at the subsequent stage high pass filter 83 is set to be higher than that of the first stage high pass filter 87, such as about 1 millihertz (MHz). The attenuation factor is set to about −20 dB. The first stage high pass filter 87 removes a low-frequency wave component from the output of the first stage amplifier circuit 81. As a result, the absolute value of the reproduction signal can be properly generated in the rectifier circuit 71.

A manufacturing method of the magnetic disk 14 will now be simply explained. The substrate 34 is prepared first. The substrate 34 is mounted on a sputtering apparatus having a chamber in which a vacuum environment is established. In the chamber, a FeCoTa target is set, for example. The underlayer 35 is formed on the substrate 34. The non-magnetic intermediate layer 36 is formed on the underlayer 35. The sputtering apparatus is used to form the layers. In the sputtering apparatus, a tantalum target or a ruthenium target is similarly set.

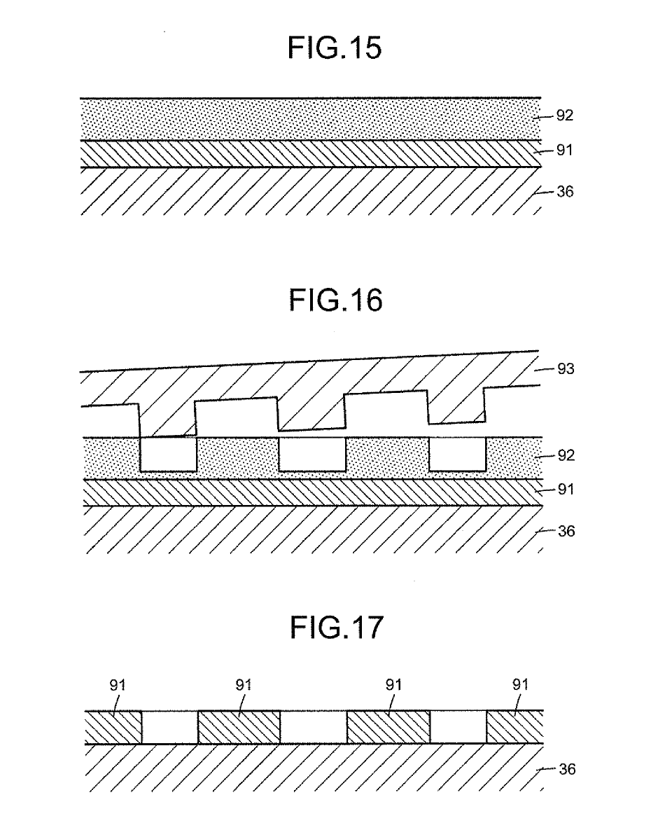

Then, as illustrated in FIG. 15, a solid film of a magnetic film 91 is formed on the non-magnetic intermediate layer 36. The magnetic film 91 is formed of a cobalt ferrite alloy, for example. The sputtering apparatus is used for the lamination, for example. A resist is applied to coat the magnetic film 91 by forming a resist film 92 on the magnetic film 91.

Then, as illustrated FIG. 16, the resist film 92 is patterned using nanoimprint lithography. A mold 93 is pressed on the resist film 92 to cover areas corresponding to the magnetic dots 31, and the magnetic bodies 45, 47, 48, and 51. The resist film 92, when formed, is exposed after the mold-pressing. As illustrated in FIG. 17, an etching treatment is performed after the exposure. The magnetic film 91 is scraped to form the magnetic dots 31, and the magnetic bodies 45, 47, 48, and 51 therefrom. In other words, the magnetic dots 31, and the magnetic bodies 45, 47, 48, and 51 are formed of the magnetic film 91 remaining on the non-magnetic intermediate layer 36.

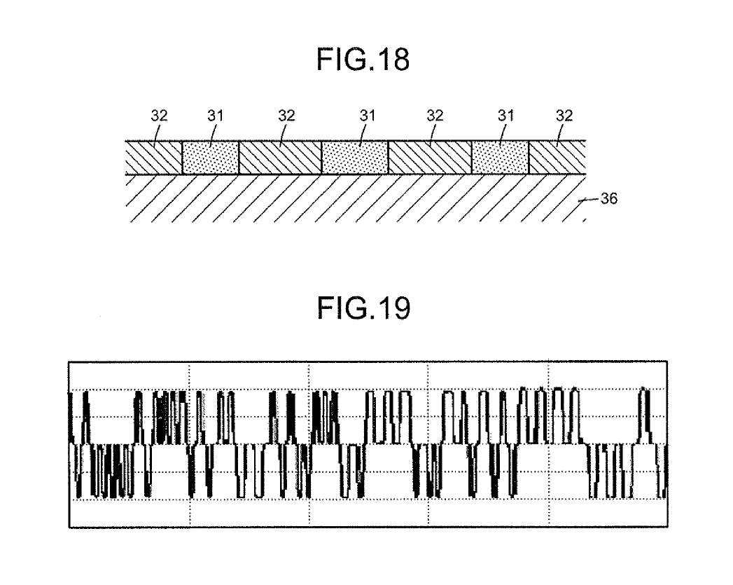

After the magnetic dots 31, and the magnetic bodies 45, 47, 48, and 51 are formed, a filler is applied to coat the non-magnetic intermediate layer 36. The filler comprises a silicon dioxide. A spin-coat method is employed for the coating. Once the filler is cured, a planarization polishing process is performed. As a result, as illustrated in FIG. 18, a space among the magnetic dots 31, and the magnetic bodies 45, 47, 48, and 51 is filled with the filler. The filler forms the non-magnetic substances 32 and 46. Thus, the surface of the recording layer 37 is planarized. The protective film 38 is formed on the recording layer 37. A chemical vapor deposition (CVD) method is employed on the formation of the layers. The lubricating film 39 is deposited to coat the protective film 38. A so-called dipping method is employed for the coating. In the dipping method, the substrate 34 is dipped into a solution containing perfluoropolyether, for example.

Ion injection may be employed to form the magnetic dots 31 and the magnetic bodies 45, 47, 48, and 51. Once the ion is injected into the magnetic film 91, the magnetic film 91 is converted to a soft magnetic substance. The ion nullifies the magnetic coercive force of the magnetic film 91. Therefore, the non-magnetic substance 32 can be formed. This ion injection can improve the surface flatness of the recording layer 37.

The servo sector area 28 is established in the magnetic disk 14. When establishing the servo sector area 28, the recording layer 37 of the magnetic disk 14 is exposed to a high-frequency write signal. The magnetic disk 14 may be mounted on a servo track writer (STW), or incorporated in the HDD 11. The write head element 55 of the electromagnetic conversion element faces the magnetic disk 14. In synchronization with the rotation of the magnetic disk 14, a high-frequency signal is supplied to the write head element 55. According to the high-frequency signal, the magnetic field to be applied to the write head element 55 is alternated between an N-pole and an S-pole at a predetermined period. As a result, the N-pole and the S-pole are randomly arranged on a recording track, as illustrated in FIG. 19. Because magnetic films used for the bit-patterned media have magnetic domains with a strong exchange coupling force therebetween, each of the magnetic bodies 45, 47, 48, and 51 has unidirectional magnetization inevitably. Even if the writing magnetic field is applied to a part of each of the magnetic bodies 45, 47, 48, and 51, the reversal of the magnetization is induced at each of the magnetic bodies 45, 47, 48, and 51 as a whole.

In the magnetic bodies, the high-frequency write signal is used to magnetize the servo sector area 28 in which the N-pole and the S-pole are randomly arranged. In the magnetic bodies 45, 47, 48, and 51 with the N-pole and the S-pole adjacent to each other, the magnetization is stable, resulting in avoiding the magnetization reversal. In particular, when the intervals among the magnetic bodies 45, 47, 48, and 51 and a half-cycle of the high-frequency write signal correspond to one another, the number of combinations of adjacent N-pole and the S-pole is reliably increased. Therefore, the possibility of the magnetization reversal is dramatically decreased.

In the conventional bit-patterned media, all the magnetic bodies 45, 47, 48, and 51 are unidirectionally magnetized. Therefore, the servo sector area 28 with one pole is positioned in the non-magnetic substance 46. Accordingly, only the unidirectional reproduction signal is supplied to the HDC 59 upon tracking servo control. As described-above, if a unidirectional reproduction signal is generated due to the rectifier circuit 71, the HDC 59 can perform the signal processing as in the conventional one. Upon tracking servo control process, the HDC 59 can also perform the process same as that of the conventional HDC. Moreover, the tracking servo control process can be used for the conventional bit-patterned media. Even though the magnetization reversal is induced by heat fluctuation or aging deterioration, only the unidirectional reproduction signal is supplied to the HDC 59.

As described above, a magnetic storage medium in an embodiment has a servo pattern with which magnetization is reliably maintained.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic storage apparatus comprising:
a magnetic storage medium that comprises a servo pattern in which magnetic bodies magnetized to one of an S-pole and an N-pole are discretely arranged in a non-magnetic substance at least in a recording track line direction;
an electromagnetic conversion element configured to output a reproduction signal according to a magnetic field leaking from the magnetic bodies;
a rectifier circuit configured to receive the reproduction signal swinging from positive to negative and vice versa corresponding to a magnetic pole, and generate a reproduction signal swinging to either a positive or negative direction according to the reproduction signal; and
a control circuit configured to cause the electromagnetic conversion element to be positioned to a single recording track on the magnetic storage medium according to the reproduction signal generated in the rectifier circuit.

2. The magnetic storage apparatus according to claim 1, further comprising an offset correction circuit that is connected between the rectifier circuit and the electromagnetic conversion element, and configured to correct a direct current offset obtained from the reproduction signal swinging from positive to negative and vice versa and a reference voltage.

3. The magnetic storage apparatus according to claim 1, further comprising a high pass filter that is configured to receive the reproduction signal before demodulation of the reproduction signal, and is connected at a subsequent stage of the rectifier circuit.

4. The magnetic storage apparatus according to claim 3, further comprising a first stage high pass filter that is connected at a preceding stage of the rectifier circuit, and configured to have a lower cutoff frequency than that of the high pass filter.

5. A manufacturing method of a magnetic storage medium, the method comprising:
magnetizing, in a servo pattern of the magnetic storage medium, magnetic bodies that are discretely arranged in a non-magnetic substance at least in a recording track line direction with a high-frequency write signal.

6. The manufacturing method according to claim 5, wherein an interval among the magnetic bodies is adjustable to a half-cycle of the high-frequency write signal.
